(19) United States
(12) Patent Application Publication
(10) Pub. No.: US 2018/0076432 A1
(43) Pub. Date: Mar. 15, 2018

(54) SHOCKPROOF BATTERY BOX STRUCTURE

(71) Applicant: I-SIN PENG, Taichung (TW)

(72) Inventor: I-SIN PENG, Taichung (TW)

(21) Appl. No.: 15/822,069

(22) Filed: Nov. 24, 2017

(51) Int. Cl. H01M 2/10; H01M 2/04

(52) U.S. Cl. CPC H01M 2/1094; H01M 2220/20; H01M 2/04; H01M 2/1072

(57) ABSTRACT

A shockproof battery box structure comprises a receiving box and at least two shockproof pads. A battery applying for boat or ship may be arranged in the receiving box and the bottom portion of the battery may correspond to the radial protruding portion and the two depression portions for cooperating with each other. The battery may abut against the pin portion of each shockproof pad to achieve the shockproof effect. Each shockproof pad made of rubber or plastic materials press-fits in corresponding holes tightly so as to achieve the shockproof effect and prevent water from permeating into the receiving box to resulting in battery leakage and damage.

### FIELD OF THE INVENTION

The present invention relates to a battery box, and more particularly to a shockproof battery box structure.

### BACKGROUND OF THE INVENTION

The battery applying for boat or ship is arranged in a box. However, the box is not totally closed. Therefore, the water may be permeated into the box to result in battery damage. In addition, the box is arranged on the boat or ship, the box may be slid and unstable due to wet. Even the box is arranged on an anti-skidding pad, but the water may be also permeated into the box to make inconvenience.

In view of the foregoing circumstances, the inventor has invested a lot of time to study the relevant knowledge, compare the pros and cons, research and develop related products. After quite many experiments and tests, the “shockproof battery box structure” of this invention is eventually launched to improve the foregoing shortcomings, to meet the public use.

### SUMMARY OF THE INVENTION

An objective of this invention is providing a shockproof battery box structure. A battery applying for boat or ship may be arranged in the receiving box and the bottom portion of the battery may correspond to the radial protruding portion and the two depression portions for cooperating with each other. The battery may abut against the pin portion of each shockproof pad to achieve the shockproof effect. At the same time, each shockproof pad made of rubber or plastic materials press-fits in corresponding holes tightly so as to achieve the shockproof effect and prevent water from permeating into the receiving box to resulting in battery leakage and damage. And the base portion may achieve the anti-skidding effect so as to prevent from moving due to the shake of boat or ship.

To achieve above objectives, a shockproof battery box structure comprises a receiving box, at least two holes are formed at a bottom portion thereof, and the at least two holes are symmetrically arranged and spaced apart from one another; and at least two shockproof pads, press-fitting in the corresponding holes, and one part of each shockproof pad is arranged in the receiving box and the other part thereof is arranged outside of the receiving box.

In some embodiment, the shockproof battery box structure further comprises a cover, the cover covers on the receiving box.

In some embodiment, two armrests are respectively extended outwardly from two opposite outer surfaces of the receiving box.

In some embodiment, each shockproof pad includes a base portion and a pin portion, the pin portion passes through and press-fits in the corresponding hole and part of the pin portion is arranged in the receiving box, and the base portion contacts with the outer bottom surface of the receiving box and arranged outside of the receiving box.

In some embodiment, a radial protruding portion is formed at center of the inner bottom surface of the receiving box so that two depression portions are respectively formed adjacent to the two armrests.

In some embodiment, two armrest cover portions are formed at the cover and corresponding to the two armrests so as to cover the two armrests.

Further features and advantages of the present invention will become apparent to those of skill in the art in view of the detailed description of preferred embodiments which follows, when considered together with the attached drawings and claims.

### BRIEF DESCRIPTION OF THE DRAWINGS

All the objects, advantages, and novel features of the invention will become more apparent from the following detailed descriptions when taken in conjunction with the accompanying drawings.

FIG. 1 is an exploded view of a shockproof battery box structure of the present invention.

FIG. 2 is a perspective view of the shockproof battery box structure of the present invention viewed from the bottom thereof.

FIG. 3 is a cross-sectional view of the shockproof battery box structure of the present invention.

FIG. 4 is a cross-sectional view of the shockproof battery box structure which receives a battery.

### DESCRIPTION OF THE PREFERRED EMBODIMENT

Referring now to the drawings where like characteristics and features among the various figures are denoted by like reference characters.

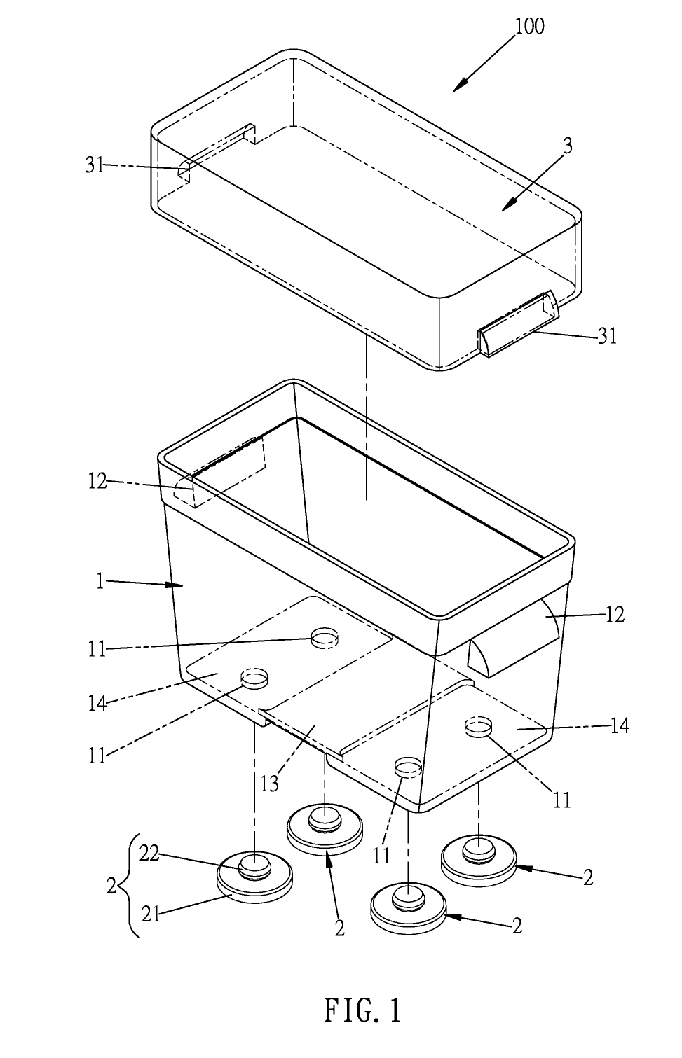

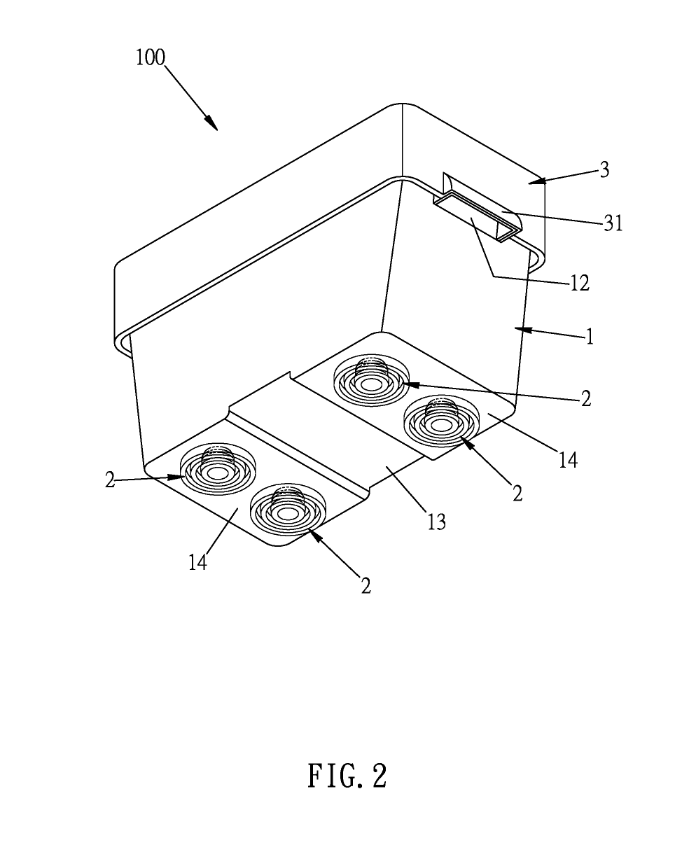

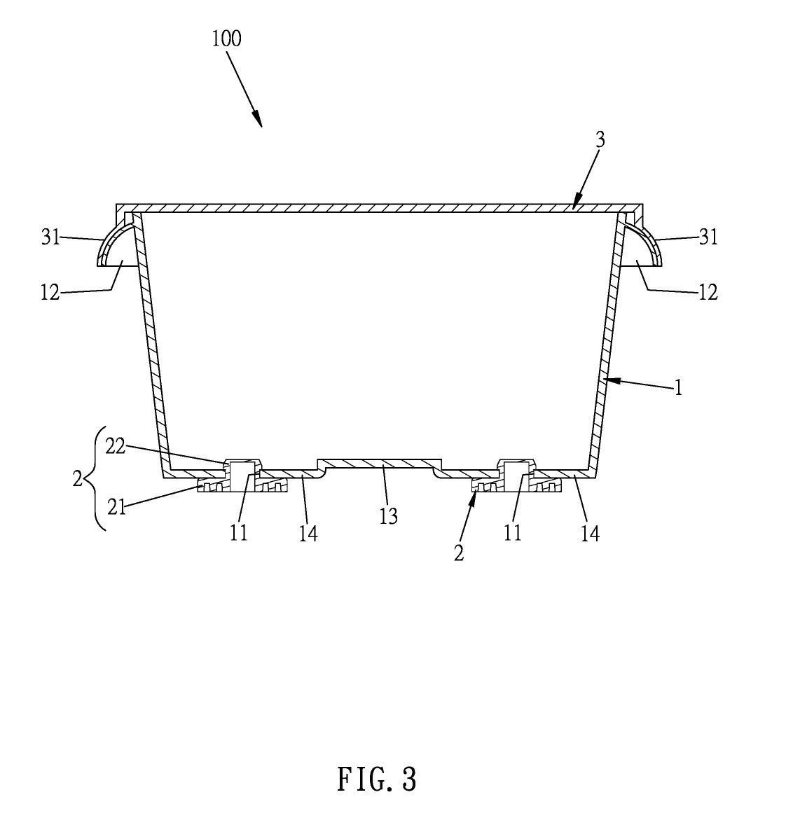

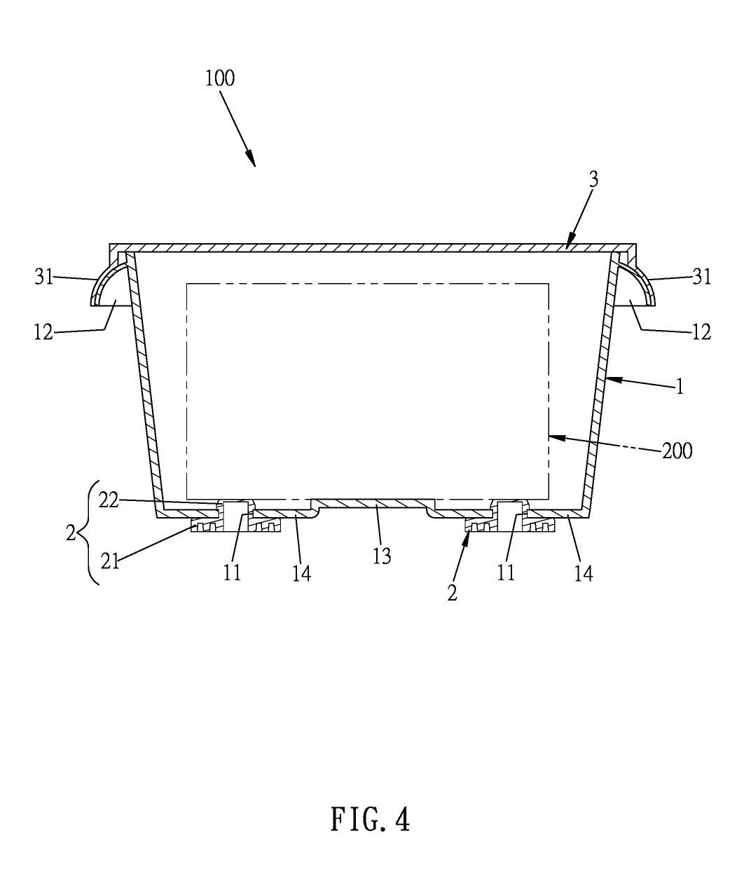

Please refer to FIGS. 1 to 4, a shockproof battery box structure 100 comprises a receiving box 1 and at least two shockproof pads 2. This invention has four shockproof pads for illustration, but not limited thereto.

At least two holes 11 are formed at a bottom portion of the receiving box 1. The at least two holes 11 are symmetrically arranged and spaced apart from one another. This invention has four holes for illustration, but not limited thereto.

Two armrests 12 are respectively extended outwardly from two opposite outer surfaces of the receiving box 1.

A radial protruding portion 13 is formed at center of the inner bottom surface of the receiving box 1 so that two depression portions 14 are respectively formed adjacent to the two armrests 12 and each depression portion 14 has each two holes 11.

Each shockproof pad 2 is made of rubber or plastic materials and may press-fit in corresponding hole 11. One part of each shockproof pad 2 is arranged in the receiving box 1 and the other part thereof is arranged outside of the receiving box 1. That is, each shockproof pad 2 includes a base portion 21 and a pin portion 22. The pin portion 22 passes through and press-fits in the corresponding hole 11 and part of the pin portion 22 is arranged in the receiving box 1. The base portion 21 contacts with the outer bottom surface of the receiving box 1 and arranged outside of the receiving box 1. Therefore, each shockproof pad 2 press-fits corresponding hole 11 so as to achieve the shockproof effect and prevent the water from permeating into the receiving box 1 to result in the battery leakage and damage. The base portion 21 may achieve the anti-skidding effect so as to prevent from moving due to the shake of boat or ship.

The shockproof battery box 100 further comprises a cover 3. The cover 3 covers on the receiving box 1. Two armrest cover portions 31 are formed at the cover 3 and corresponding to the two armrests 12 so as to cover the two armrests 12 and prevent water from permeating into the receiving box 1.

According to above mentioned structure, a battery 200 applying for boat or ship may be arranged in the receiving box 1 and the bottom portion of the battery 200 may correspond to the radial protruding portion 13 and the two depression portions 14 for cooperating with each other. The battery 200 may abut against the pin portion 22 of each shockproof pad 2 to achieve the shockproof effect. At the same time, each shockproof pad 2 made of rubber or plastic materials press-fits in corresponding holes 11 tightly so as to achieve the shockproof effect and prevent water from permeating into the receiving box 1 to resulting in battery leakage and damage. And the base portion 21 may achieve the anti-skidding effect so as to prevent from moving due to the shake of boat or ship.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention has not appeared in the prior art and features efficacy better than the prior structure which is construed to be a novel and creative invention, thereby filing the present application herein subject to the patent law.

What is claimed is:

1. A shockproof battery box structure, comprising:
a receiving box, at least two holes are formed at a bottom portion thereof, and the at least two holes are symmetrically arranged and spaced apart from one another; and
at least two shockproof pads, press-fitting in the corresponding holes, and one part of each shockproof pad is arranged in the receiving box and the other part thereof is arranged outside of the receiving box.

2. The shockproof battery box structure as claimed in claim 1, further comprising a cover, the cover covers on the receiving box.

3. The shockproof battery box structure as claimed in claim 1, wherein two armrests are respectively extended outwardly from two opposite outer surfaces of the receiving box.

4. The shockproof battery box structure as claimed in claim 1, wherein each shockproof pad includes a base portion and a pin portion, the pin portion passes through and press-fits in the corresponding hole and part of the pin portion is arranged in the receiving box, and the base portion contacts with the outer bottom surface of the receiving box and arranged outside of the receiving box.

5. The shockproof battery box structure as claimed in claim 3, wherein a radial protruding portion is formed at center of the inner bottom surface of the receiving box so that two depression portions are respectively formed adjacent to the two armrests.

6. The shockproof battery box structure as claimed in claim 2, wherein two armrest cover portions are formed at the cover and corresponding to the two armrests so as to cover the two armrests.
